(19) United States
(12) Patent Application Publication
(10) Pub. No.: US 2013/0181108 A1
(43) Pub. Date: Jul. 18, 2013

(54) SUPPORT MODULE FOR PRODUCTION COMPONENTS AND/OR ASSEMBLY COMPONENTS OF A PROCESSING UNIT AND A PROCESSING UNIT EQUIPPED WITH SUCH A SUPPORT MODULE

(71) Applicant: Johann Koepf, Halblech (DE)

(72) Inventor: Johann Koepf, Halblech (DE)

(73) Assignee: OTTO BIHLER HANDELS-BETEILIGUNGS-GMBH, Halblech (DE)

(21) Appl. No.: 13/823,204

(22) PCT Filed: Sep. 9, 2011
(86) PCT No.: PCT/EP2011/067140

§ 371 Date: Mar. 14, 2013

(30) Foreign Application Priority Data
Oct. 1, 2010 (DE) 10 2010 041 864.1

(51) Int. Cl. B23Q 1/01

(52) U.S. Cl. CPC B23Q 1/015
USPC 248/676

(57) ABSTRACT

The invention relates to a support module for production components and/or assembly components (50) of a processing unit, characterized in that it is formed at least approximately in a prismatic, preferably cuboidal manner and, on at least one side face (3, 5, 7) of the prism, has a predetermined fastening grid of prepared fastening points (31), more particularly fastening holes and/or fastening pins and/or fastening hooks, for attaching the components (50, 52, 54, 56, 62, 66, 68), and in that it also has means for fixing it to a base frame (37) or the like of the processing unit, wherein the support module (1) is configured such that it can be joined together with at least one identical support module (1) to form a modular support system. The invention also relates to a processing unit having a support module.

The invention relates to a support module for production components and/or assembly components of a processing unit and to a processing unit equipped with a support module of this type.

Processing units of the type presently under consideration are used for mass production and/or mass assembly of components and modules, it being possible for the manufacturing processes and/or assembly processes to comprise steps of material introduction, material separation, material shaping, drilling, thread formation, connection by welding, soldering, gluing, screwing or riveting, printing and so forth.

Examples of products which are conventionally produced using processing units of this type are hose clips, window and door fittings, belt buckles, furniture fittings, lock parts, electrical contact connection elements, such as plugs and plug sockets, spark plugs and so forth. Various materials may be used in the production of mass-produced parts of this type, in particular metals and plastics materials.

In accordance with the wide range of different shapes, sizes and compositions of the products which are to be produced using processing units of this type, processing units are required which can be adapted in a simple manner to the requirements for producing a respective specific product.

Thus, inter alia, processing units are known which comprise production components and/or assembly components which are numerically controllable, that is to say computer-controlled and thus programmable NC processing modules. A degree of flexibility is achieved when setting up a processing unit in that the NC processing modules can be programmed in accordance with the specific purpose thereof. It is also known to provide NC modules of this type, such as flexible slides or the like, on a shared machine frame, for example in the form of a solid assembly plate, which comprises a grid of holes for mounting modules of this type at respective fastening locations. The manufacturing components and/or assembly components presently under consideration are conventionally connected to supply lines, such as power supply lines and/or data lines and/or fluid lines, in such a way that, in particular in processing units having a relatively large number of manufacturing components and/or assembly components, it is difficult to lay supply lines of this type in an ordered, compact manner.

The object of the present invention is to increase the flexibility of a processing unit of this type as regards the adaptability to product-specific processing requirements of the parts which are to be produced.

To achieve this object, according to the invention, a support module for production components and/or assembly components of a processing unit is proposed, and is characterised in that it is in the form of a prismatic, in particular cuboid hollow block, which comprises mutually opposing base faces, prism side faces between the base faces, and a hollow space extending from one base face to the other, a predetermined fastening grid of prepared fastening points for mounting the components being provided on at least one of the prism side faces, at least one access hole which opens into the hollow space, in particular a grid of a plurality of access holes which open into the hollow space, further being provided in at least one of the prism side faces.

The support modules according to the invention are in particular configured in such a way that they can be joined together and combined to form a support system which makes it possible to attach various production components and/or assembly components to the fastening points in a wide range of positions, in such a way that a processing unit equipped with a modular support system of this type or a support module of this type can be adapted in a flexible and simple manner by arranging the production components and/or assembly components in a corresponding manner at prepared fastening points, this applying in particular in connection with the use of individually controllable production components and/or assembly components, such as NC processing modules. Preferably, the support module comprises means for fixing it to a base frame or foundation of a respective processing unit.

The hollow space of the support module is used as a line and cable duct for supply lines of production components and/or assembly components. Supply lines of this type may be current supply lines, data lines, hydraulic lines, pneumatic lines, cooling medium lines and so forth. The support module according to the invention is configured in such a way that it is possible in a simple manner to lay supply lines of this type in a protected and compact manner. The access holes, through which the supply lines laid in the hollow space can be passed outwards to the production components and/or assembly components which are connected thereto, are also used for this purpose. In particular in the preferred case where there is a plurality of access holes distributed over the length of the support module, there is thus the option of keeping supply line portions which extend outside the hollow space to the production components and/or assembly components very short, that is to say to introduce them into the hollow space on a short path from a respective production component and/or assembly component on the support module. Guiding the lines in this compact and ordered manner leaves space for a maximally optimised arrangement of a relatively large number of production components and/or assembly components on the support module. The supply lines which are bundled in the hollow space when the support module is used in a processing unit can be passed outwards, or if applicable into the hollow space of a connected further support module, through at least one open base face of the hollow block. If required, access holes may also be used for leading supply lines of this type away to the outside. The access holes should be of a correspondingly large size, and should not fall below a minimum diameter dimension of 0.07 m, partly so that an assembler can reach a hand into the hollow space of the support module through an access hole of this type, so as to be able to access supply lines in the hollow space or carry out assembly operations in the hollow space, for example mounting a counter nut of a stud bolt, which is passed through the fastening hole, of a production component and/or assembly component.

The fastening points may be fastening holes and/or fastening pins and/or fastening hooks and/or clamping elements or the like, a fastening grid of fastening holes being preferred.

The fastening holes may be through-holes, that is to say open into the hollow space. They may be prepared with an internal thread or sized for receiving pass-through sleeves. In further embodiments, the fastening holes may for example be blind holes.

Preferably, the support modules according to the invention are of an approximately cuboid shape, in such a way that a plurality of identical support modules according to the invention can be combined into different standard arrangements in a simple manner to form a modular support system. Examples of standard arrangements of this type are arrangement in a row, arrangement at a 90° angle, a T arrangement, a U arrangement, and a rectangular arrangement. In principle, support modules according to the invention may also be shaped in such a way that they can, for example, be joined together and combined mutually orthogonally, in three spatial directions, to form a three-dimensionally branched support system.

The flexibility of a modular support system of this type can also be further increased if, in accordance with an embodiment of the support module according to the invention, a plurality of prism side faces, that is to say preferably a plurality of cuboid side faces, has a predetermined fastening grid of prepared fastening points, which as stated above are fastening holes and/or fastening pins and/or fastening hooks and/or clamping elements or the like for mounting components. Preferably, the fastening grids are the same on all of the prism side faces of the support module which are equipped therewith. In accordance with a further preferred variant of the invention, the length of the prism side edges corresponds to a whole multiple of the length of the prism base edges of the support module. Overall, it is advantageous for the prism edges to correspond to a respective integer multiple of a smallest grid dimension d of the fastening grid.

Moreover, in accordance with a preferred development of the invention, it is proposed that the support module is configured in such a way that it can be joined together with at least one identical support module to form a modular support system, it being possible to connect a fastening grid of fastening points of the support module systematically to a fastening grid of fastening points of the other identical support module while maintaining a particular fastening grid dimension at the transition between the support modules. A solution of this type makes it possible to attach production components and/or assembly components to fastening points of the two support modules via the transition point between the support modules, without sacrificing the orientation, at a predetermined grid dimension or grid layout.

In accordance with a further preferred embodiment of the support module according to the invention, the fastening grid comprises a row of fastening holes, extending parallel to a prism side edge of the support module and having a predetermined hole spacing, the fastening holes closest to the prism base edges of the support module having a half hole spacing from the respective prism base edges, and the spacing of the edge rows of fastening holes from the respective closest adjacent prism side edge also corresponding to the half hole spacing. Two identical support modules of this construction can thus be joined together to form a modular support system in such a way that the grid dimension hole distance is maintained across the connection point. A development of this last embodiment of the support module is characterised in that the fastening grid comprises at least four rows of fastening holes extending parallel to a prism side edge of the support module, and in that these rows of fastening holes extend symmetrically about a plane which is parallel to the prism side edges and which centrally divides and extends orthogonal to the prism side face provided with the rows of fastening holes. Preferably, the spacings between the rows of holes correspond to a whole multiple of the grid dimension and thus of the hole spacing between two holes of a respective row. It is further preferred for the rows of holes to have the same hole spacings and hole diameters. A fastening hole layout of this type defines a fastening point grid which can be adapted in a simple manner to standardised fastening dimensions of production components and/or assembly components which are to be attached.

A wide range of mounting options are made possible by an embodiment of the support module according to the invention in which all of the prism side faces of the prism casing, that is to say in the case of the cuboid all four mutually adjacent cuboid side faces of the support module, are prepared with identical fastening grids, it also optionally being possible for a fastening grid to be used for assembling the support module on a base frame of the processing unit, and thus to provide the respective means for fixing the support module to the base frame.

In accordance with an embodiment which has been found to be expedient in practical tests, three mutually adjacent cuboid side faces of the support module, which in this case is a cuboid, are prepared with identical fastening grids, the remaining cuboid side face comprising means for fixing the support module to the base frame of the processing unit. An embodiment modified from this comprises fastening grids on a plurality of cuboid side faces, but at least two of said fastening grids are different.

Preferably, the support module is a single-piece hollow cast metal part, preferably a cast steel part. In other embodiments, the support module may for example be formed from plate elements. These are for example metal plate elements, for example made of steel, which are welded together.

A development of the invention provides that the support module comprising a hollow space comprises in the prism side walls a central hole row of access holes extending parallel to the prism side edges. These access holes should each individually be large enough for an assembler to be able to reach through a respective access hole into the inside of the support module.

Further, the access holes are used in the aforementioned manner for passing lines through, such as electric lines, data cables, lubricant lines, cooling medium lines, pneumatic lines and the like, which are attached to production components and/or assembly components on the outside of the support module and are laid in a protected manner as they continue to extend inside the hollow space of the support module. The rows of through-holes are preferably provided in an outwardly open groove, which extends parallel to the prism side edges in the centre of a respective prism side face. This groove can if necessary receive a cover strip which seals the access holes towards the outside.

The invention further relates to a processing unit comprising a support system consisting of at least one support module according to the invention, the processing unit comprising a base frame to which the support module is fixed in a predetermined orientation. The processing unit further comprises production and assembly components which are mounted ready for operation in a predetermined arrangement on prepared fastening points of the support module, at least some of the production components and/or assembly components being connected to supply lines, which are passed into the hollow space through access holes of the support module. The production components and/or assembly components are set up so as to carry out processing processes corresponding to the respective production tasks and/or assembly tasks. Preferably, the processing unit comprises a plurality of support modules according to the invention which are joined together to form a support system.

The production components and/or assembly components may for example be NC production modules and assembly modules, which can be programmed individually or can be controlled by a control means.

Preferably, the production components and/or assembly components comprise modules from the following group: welding module, thread-forming module, screwing module, introduction module, feed module, pick-and-place module, machining laser, press, cold-forming module, in particular a bending module or a punching module, insulating module, soldering module, gluing module, plastics material extrusion module, inscription module, measuring module, camera module, control module.

In accordance with a development of the production unit according to the invention comprising a plurality of support modules, all of the support modules are formed identically. However, an alternative variant provides that support modules of different but mutually matched sizes form a modular support system. The size matching may for example be such that support modules only differ in the prism side edge length thereof, the length of a larger module corresponding to a whole multiple of the length of a smallest base module.

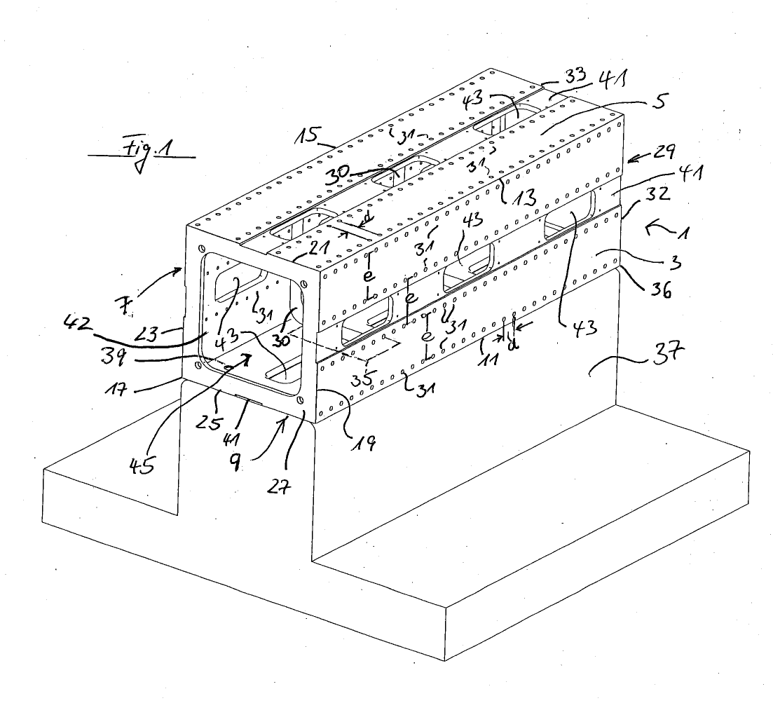

Embodiments of the invention are described in greater detail in the following with reference to the drawings, in which:
FIG. 1 is a perspective drawing of a support module according to the invention on a base frame of a processing unit, the rest of which is not shown;

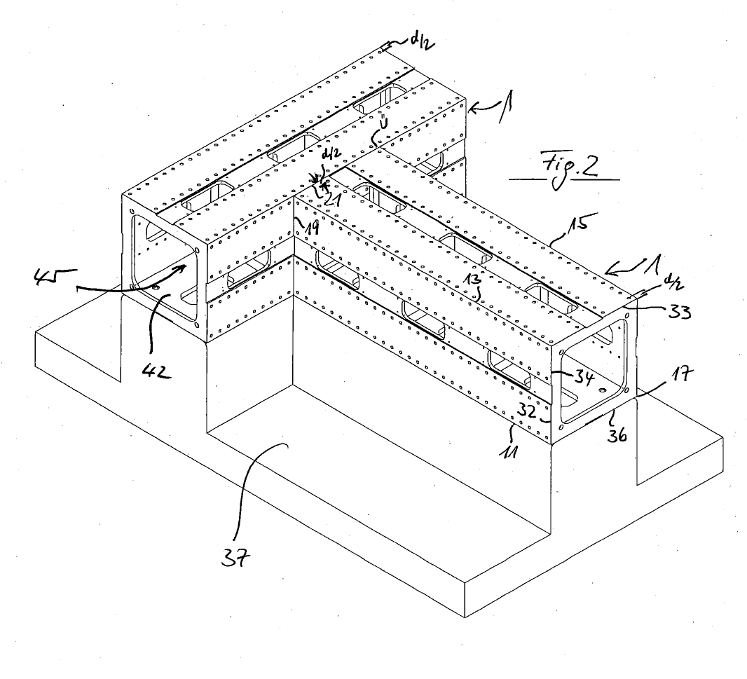

FIG. 2 shows a modular support system consisting of two support modules of the construction shown in FIG. 1 joined together in a T arrangement on a respective base frame of a processing unit, the rest of which is not shown;

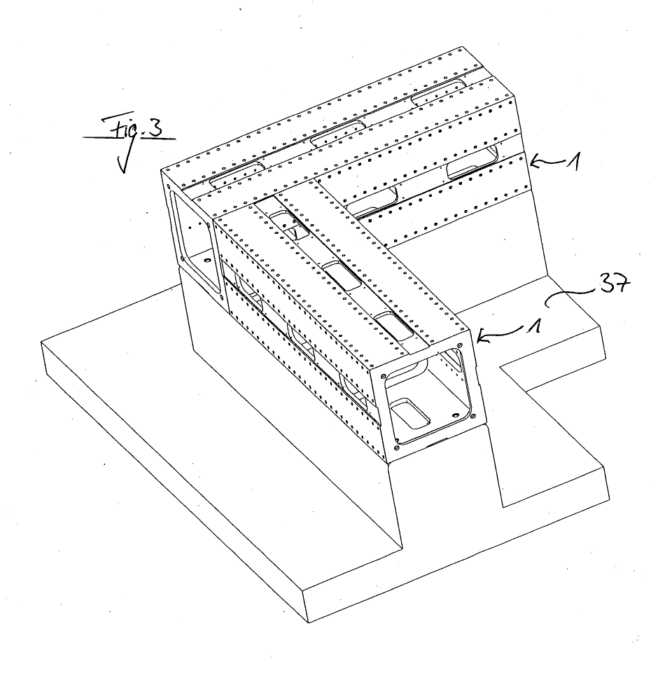

FIG. 3 shows two support modules of the construction shown in FIG. 1 in a diagonal angular arrangement on a respective base frame of a processing unit, the rest of which is not shown;

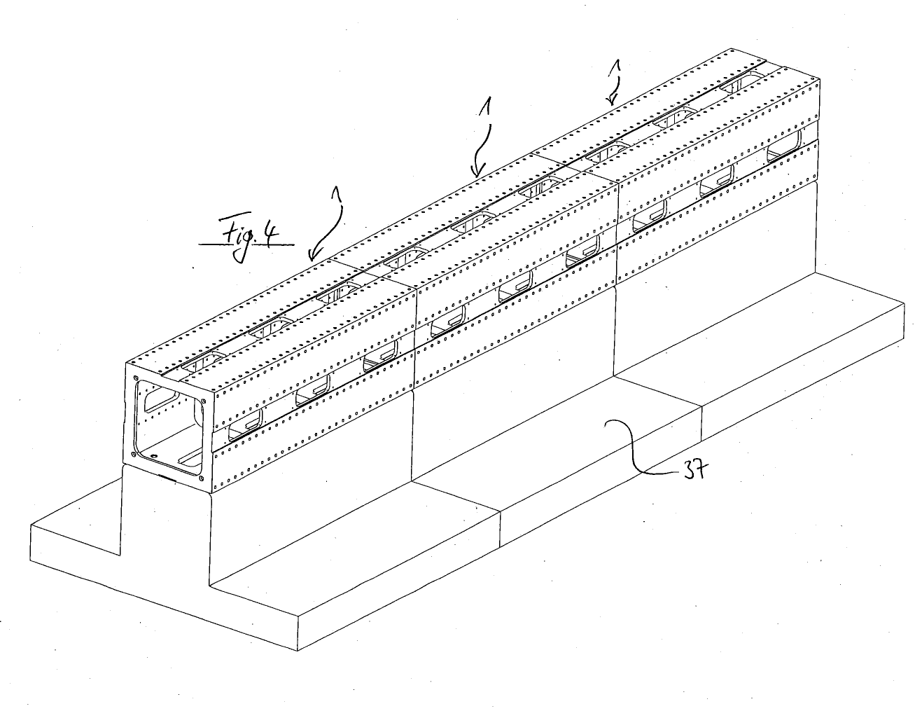

FIG. 4 shows a row-arrangement of three support modules of the construction shown in FIG. 1 joined together to form a modular support system on a base frame of a processing unit, the rest of which is not shown;

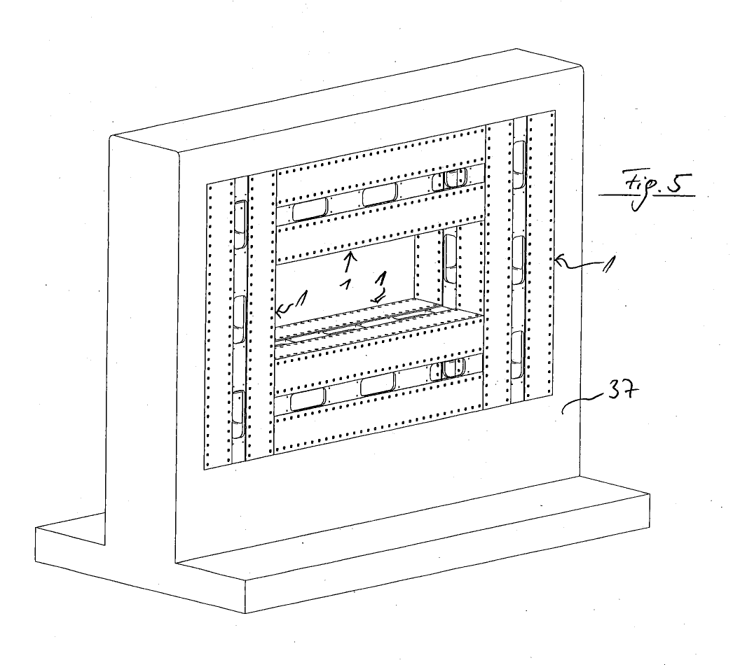

FIG. 5 shows a rectangular arrangement, positioned upright, of four support modules of the construction shown in FIG. 1 joined together to form a modular support system on a base frame of a processing unit, the rest of which is not shown; and

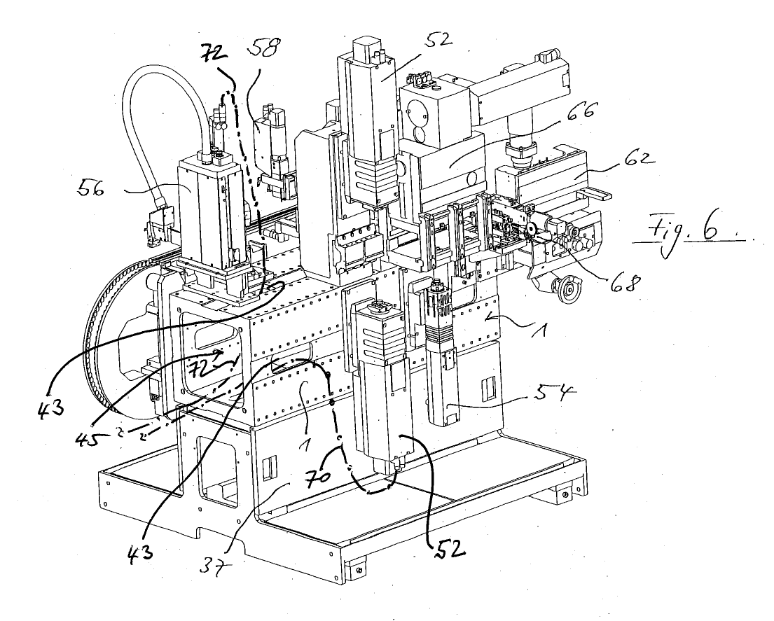

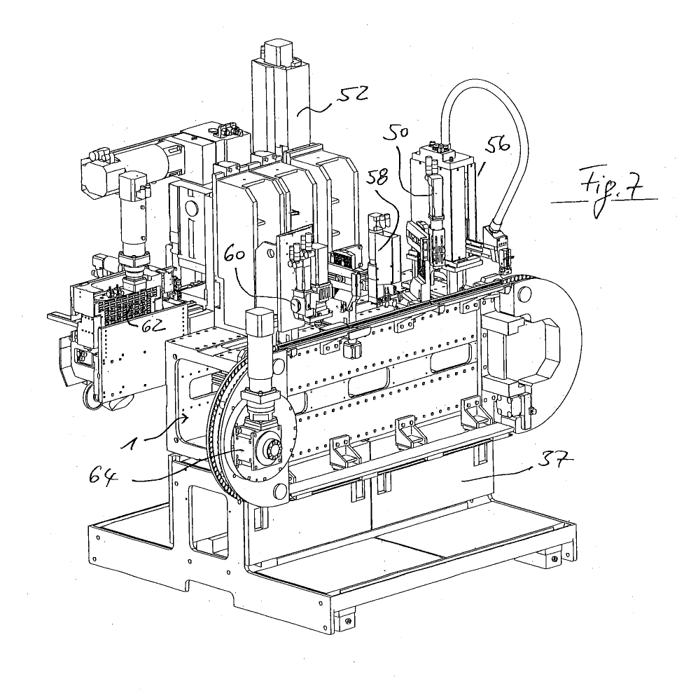

FIG. 6 and FIG. 7 are perspective drawings of a processing unit according to the invention from two different viewing directions.

The support module 1 shown in a perspective drawing in FIG. 1 has the basic shape of a prism, in the example specifically a cuboid having prism side faces 3, 5, 7, 9, prism side edges 11, 13, 15, 17 and prism base edges 19, 21, 23, 25, 32, 33, 34, 36 on the base faces 27, 29.

In the example, the box-like support module 1 is a single-piece hollow cast steel part having cuboid dimensions of 500 mm×500 mm×1500 mm. The prism side edges are thus three times the length of the prism base edges. In the hollow space 45 of the support module 1, reinforcing ribs 30 parallel to the base faces 27, 29 are provided.

Four similar rows of fastening holes 31 are provided in each of the prism side faces 3, 5, 7, 9.

The rows of fastening holes extend parallel to the side edges 11, 13, 15, 17 of the support module and have holes 31 of equal size having an equally large hole spacing d corresponding to the grid dimension, which is 50 mm in the example. The rows of fastening holes of the cuboid side face 3 extend symmetrically about a central plane 35 parallel to the prism side edges 11, 13. The fastening grid of the cuboid side faces 3, 5 and 7 are identical, in such a way that corresponding symmetries of the rows of holes are also present for the side faces 5 and 7. Preferably, the fastening holes 31 are holes having a diameter of for example 10-15 mm for receiving pass-through sleeves, which are used for receiving fastening screws in a centered manner for attaching production components and/or assembly components. The fastening holes may have threads or simply be provided for passing stud bolts through.

The spacing e between the rows of holes of a respective cuboid side face 3, 5, 7 corresponds to a whole multiple of the grid dimension d. In the example, e=150 mm.

The cuboid side face 9 of the support module 1, which side face is positioned on the base frame 37, does not have the fastening grid of the other cuboid side faces 3, 5, 7, but instead has its own grid of fastening holes 39, which is adapted to a complementary fastening grid of the base frame 37. However, in an alternative embodiment of the support module 1, the cuboid side face 9 could also be configured with a fastening grid which corresponds to that of the other cuboid side faces 3, 5, 7.

An external groove 41, in which three access holes 43 are provided equidistantly, extends along the cuboid side face 3, centrally between and parallel to the side edges 11, 13. Access holes 43 of this type are likewise provided in the other cuboid side faces 5, 7 and 9 at corresponding points. They make it possible to access the internal hollow space 45 of the support module 1, that is to say they are large enough that an assembler can reach a hand through the access holes 43. In the example, the access holes 43 are of an approximately rectangular shape, with the dimensions 100 mm×250 mm (height×width). For an access hole 43, the smallest diameter dimension (in this case the height) should not be less than 70 mm. The access holes 43 are also used for passing lines through, which may conventionally also be laid in part along the grooves 41, and are conventionally connected to production components and/or assembly components.

The grooves 41 may if required be covered on the outside with a cover strip which is to be laid therein, so as to seal the access holes 43 towards the outside.

On the base faces (end faces) 27, 29, the support module is largely open towards the hollow space 45, that is to say it has holes 42 which in the example are larger than the access holes 43 by a multiple.

FIG. 2 shows what is known as a T arrangement of two identical support modules of the type shown in FIG. 1. In this regard, it should again be noted that the edges 11, 13, 15, 17, 19, 21, 23, 32, 33, 34, 36 of the respective support module each have a half hole spacing d/2 from holes which are directly adjacent to the respective edge, in such a way that the grid dimension is maintained at the transition Ü between the two support blocks.

This also applies in the diagonal angular arrangement of two identical support modules in accordance with FIG. 3 and to an arrangement, in a row, of for example three identical support modules in accordance with FIG. 4. Further possible combinations would be for example a Z arrangement, a U arrangement or a rectangular arrangement. A rectangular arrangement which is set up vertically is shown in FIG. 5. In this drawing, it can also be seen that support modules 1 can be assembled in an upright arrangement and in a horizontal arrangement. In principle, it would also be possible to continue the support system orthogonal to the rectangular plane spanned by the support modules 1 by mounting further support modules 1 transverse thereto. By using wedge adapters or the like, oblique branches, that is to say non-perpendicular branches, could also be formed.

It can be seen from FIG. 2-5 that support modules 1 according to the invention can be combined in a flexible manner to form support systems of different configurations, so as to arrange production components and/or assembly components for respective specific production tasks and/or assembly tasks.

FIGS. 6 and 7 are perspective drawings of a processing unit comprising a support module 1 according to the invention from opposite viewing directions. In these drawings, it can be seen that various production components and/or assembly components are fixed in a predetermined arrangement with respect to one another on the support module. In the example, the production components and/or assembly components comprise NC slides 50, 52, 54, an NC pick-and-place module 56, an NC thread former 58, an NC screwdriver 60, an NC feed 62, an NC drive comprising a transport belt 64, an NC press 66 and an NC drive comprising a welding device 68.

In FIGS. 6 and 7, supply lines of the production components and/or assembly components (50-68) are not shown in a concrete manner, even though they are present in a respective processing unit of the type shown. To represent them, in FIG. 6, two of a plurality of supply lines are indicated schematically by chain lines 70 and 72 respectively. They are connected to respective components 52, 56 and passed into the hollow space 45 of the support module 1 through a respective closest accessible access hole 43.

1. Support module for production components and/or assembly components of a processing unit, characterised in that it is in the form of a prismatic, in particular cuboid hollow block, which comprises mutually opposing base faces, prism side faces between the base faces, and a hollow space extending from one base face to the other, a predetermined fastening grid of prepared fastening points for mounting the components being provided on at least one of the prism side faces, at least one access hole which opens into the hollow space, in particular a grid of a plurality of access holes which open into the hollow space, further being provided in at least one of the prism side faces.

2. Support module according to claim 1, characterised in that it is open towards the hollow space at at least one base face, in particular at both base faces.

3. Support module according to claim 2, characterised in that the fastening points comprise fastening holes and/or fastening pins and/or fastening hooks and/or clamping elements.

4. Support module according to claim 1, characterised in that it comprises a predetermined fastening grid of prepared fastening points for mounting the components on a plurality, in particular three, of prism side faces, and further comprises in each of these prism side faces at least one access hole, separate from the fastening points, which opens into the hollow space, in particular a grid of a plurality of access holes which open into the hollow space.

5. Support module according to claim 4, characterised in that the fastening grids of prepared fastening points are the same on at least two, in particular all, of the prism side faces equipped therewith.

6. Support module according to claim 1, characterised in that the support module is configured in such a way that it can be joined together with at least one identical support module in different selectable positions, in particular in a row arrangement, a diagonal arrangement or a T arrangement, to form a modular support system, it being possible to connect a fastening grid of fastening points of the support module systematically to a fastening grid of fastening points of the other identical support module while maintaining a particular fastening grid dimension (d) at the transition between the support modules.

7. Support module according to claim 1, characterised in that the prism side faces are defined by prism side edges, in that the prism base faces are defined by prism base edges extending transverse to the prism side edges, and in that the fastening grid comprises at least one row of fastening holes extending parallel to a prism side edge of the support module at a predetermined mutual hole spacing (d), the fastening holes positioned closest to the prism base edges of the support module having a half hole spacing (d/2) from the respective prism base edges, and the spacing of the edge rows of fastening holes from the respective closest adjacent prism side edge corresponding to the half hole spacing (d/2).

8. Support module according to claim 7, characterised in that the fastening grid comprises at least four rows of fastening holes extending parallel to a prism side edge of the support module, and in that these rows of fastening holes extend symmetrically about a central plane which is parallel to the prism side edges and which centrally divides and extends orthogonal to the prism side face provided with the rows of fastening holes.

9. Support module according to claim 6, characterised in that prism side edges are longer by a whole multiple than the prism base edges, and in that the length of the prism side edges corresponds to a whole multiple of the fastening grid dimension (d) or the hole spacing (d) corresponding to the fastening grid dimension.

10. Support module according to claim 7, characterised in that the spacing (e) between rows of holes of the fastening grid corresponds to a whole multiple of the hole spacing (d) corresponding to the fastening grid dimension (d).

11. Support module according to claim 1, characterised in that the prism side faces comprise a central hole row of access holes extending parallel to the prism side edges adjacent thereto.

12. Support module according to claim 11, characterised in that the respective central hole row of access holes is positioned in a central external groove, extending parallel to the prism side edges, in the respective prism side face.

13. Support module according to claim 1, characterised in that the access holes have a smallest diameter of more than 0.07 m.

14. Processing unit comprising a modular support system comprising at least a modular support module according to claim 1, a base frame to which the support module is fixed in a predetermined orientation, and comprising production components and/or assembly components, which are mounted ready for operation in a predetermined arrangement at prepared fastening points of the support module, at least some production components and/or assembly components being connected to supply lines, which are passed into the hollow space through access openings of the support module.

15. Processing unit according to claim 14, characterised in that the production components and/or assembly components comprise NC production modules and assembly modules.

16. Processing unit according to either claim 14, characterised in that the production components and/or assembly components comprise modules from the following group:
welding module,
thread-forming module,
screwing module,
introduction module,
feed module,
pick-and-place module,
machining laser,
press,
cold-forming module, in particular a bending module or a punching module,
insulating module,
isolating module,
soldering module,
gluing module,
plastics material extrusion module,
inscription module,
measuring module,
camera module,
control module.

17. Processing unit according to claim 14, characterised in that it comprises a plurality of said support modules combined to form a support system.
